(19) United States
(12) Patent Application Publication
(10) Pub. No.: US 2016/0378667 A1
(43) Pub. Date: Dec. 29, 2016

(54) INDEPENDENT BETWEEN-MODULE PREFETCHING FOR PROCESSOR MEMORY MODULES

(71) Applicant: Advanced Micro Devices, Inc., Sunnyvale, CA (US)

(72) Inventors: David Andrew Roberts, Santa Cruz, CA (US); Mitesh R. Meswani, Austin, TX (US); Sergey Blagodurov, Bellevue, WA (US); Dmitri Yudanov, Austin, TX (US); Indrani Paul, Round Rock, TX (US)

(21) Appl. No.: 14/747,933

(22) Filed: Jun. 23, 2015

(51) Int. Cl. G06F 12/08

(52) U.S. Cl. CPC G06F 12/0862; G06F 12/0806; G06F 2212/1021; G06F 2212/1024; G06F 2212/283; G06F 2212/6024

(57) ABSTRACT

A processor employs multiple prefetchers at a processor to identify patterns in memory accesses to different memory modules. The memory accesses can include transfers between the memory modules, and the prefetchers can prefetch data directly from one memory module to another based on patterns in the transfers. This allows the processor to efficiently organize data at the memory modules without direct intervention by software or by a processor core, thereby improving processing efficiency.

### BACKGROUND

Field of the Disclosure

The present disclosure relates generally to processors and more particularly to memory management for processors.

Description of the Related Art

A modern processor typically employs a memory hierarchy including multiple caches residing “above” system memory in the memory hierarchy. The caches correspond to different levels of the memory hierarchy, wherein a higher level of the memory hierarchy can be accessed more quickly by a processor core than a lower level. In response to a processor core issuing a request (referred to as a demand request) to access data from system memory, the processor transfers the data to one or more higher levels of the memory hierarchy so that, if the data is requested again in the near future, it can be retrieved quickly from one of the higher levels of memory (e.g., caches). To improve processing speed and efficiency, the processor can employ speculative operations, collectively referred to as prefetching, wherein the processor analyzes patterns in the data requested by demand requests. Based on the analysis, the processor then moves data from the system memory to one or more of the caches before the data has been explicitly requested by a demand request.

### BRIEF DESCRIPTION OF THE DRAWINGS

The present disclosure may be better understood, and its numerous features and advantages made apparent to those skilled in the art by referencing the accompanying drawings. The use of the same reference symbols in different drawings indicates similar or identical items.

FIG. 1 is a block diagram of a processor that employs separate prefetchers for different memory modules in accordance with some embodiments.

FIG. 2 is a block diagram of a portion of the processor of FIG. 1 illustrating a prefetcher that transfers data between memory modules in accordance with some embodiments.

FIG. 3 is a block diagram of a portion of the processor of FIG. 1 illustrating the prefetchers providing hints to each other to assist in prefetching in accordance with some embodiments.

FIG. 4 is a flow diagram of a method of prefetching data at memory modules of a processor in accordance with some embodiments.

FIG. 5 is a flow diagram illustrating a method for designing and fabricating an integrated circuit device implementing at least a portion of a component of a processing system in accordance with some embodiments.

### DETAILED DESCRIPTION OF EMBODIMENT(S)

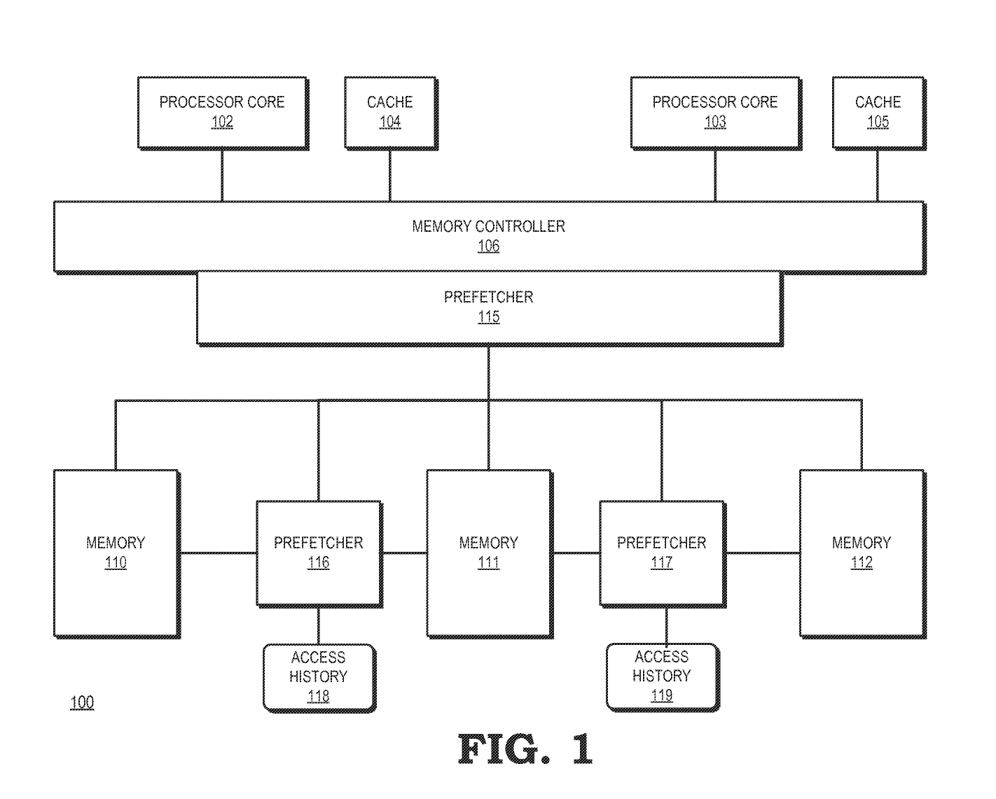

FIGS. 1-5 illustrate techniques for employing multiple prefetchers at a processor, a memory, or both, to identify patterns in memory accesses to different memory modules or memory module groups. The memory accesses can include transfers between the memory modules, and the prefetchers can prefetch data directly from one memory module to another based on patterns in the transfers. This allows the processor to efficiently organize data at the memory modules without direct intervention by software or by a processor core, improving processing efficiency.

To illustrate via an example, a processor can include or be connected to memory modules of different types, with each of the different memory types having different access characteristics such as access speed, memory density, and the like. In order to improve processing efficiency, software executing at the processor can move blocks of data between memory modules to match application behavior with the best type of memory for a given task. However, latency at the different types of memory modules can significantly impact processor performance. By prefetching data between the memory modules, latency is reduced and performance improved. Further, prefetching allows higher-latency memory types (which are typically monetarily less expensive than memory types with lower latencies) to be used for particular application behavior, reducing processor or system cost.

FIG. 1 illustrates a processor 100 that employs different prefetchers for different memory modules in accordance with some embodiments. The processor 100 can be a general purpose processor, application specific integrated circuit (ASIC), field-programmable gate array (FPGA), and the like, and can be incorporated into any of a variety of electronic devices, including a desktop computer, laptop computer, server, tablet, smartphone, gaming console, and the like. As described further herein, the processor 100 is generally configured to execute sets of instructions, organized as computer programs referred to as applications, in order to carry out tasks defined by the application program on behalf of the electronic device.

To facilitate execution of an application, the processor 100 includes processor cores 102 and 103, a memory controller 106, and memory modules 110, 111, and 112. The processor cores 102 and 103 each include an instruction pipeline and associated hardware to fetch computer program instructions, decode the fetched instructions into one or more operations, execute the operations, and retire the executed instruction. Each of the processor cores can be a general purpose processor core, such as a central processing unit (CPU) or can be a processing unit designed to execute special-purpose instructions, such as a graphics processing unit (GPU), digital signal processor (DSP), and the like or combinations of these various processor core types.

In the course of executing instructions, the processor cores 102 and 103 can generate operations to access data stored at memory of the processor 100. These operations are referred to herein as “memory accesses.” Examples of memory accesses include read accesses to retrieve data from memory and write accesses to store data at memory. Each memory access includes a memory address indicating a memory location that stores the data to be accessed. In the illustrated example, each of the processor cores 102 and 103 is associated with a cache (caches 104 and 105, respectively). In response to generating a memory access, the processor core attempts to satisfy the access at its corresponding cache. In particular, in response to the data corresponding to the memory address of the memory access being stored at the cache, the cache satisfies the memory access. In response to the data corresponding to the memory address not being stored at the cache, the memory access is provided to the memory controller 106 for retrieval to the cache. Once the data has been retrieved to the cache, the memory access can be satisfied at the cache. It will be appreciated that although the caches 104 and 105 are illustrated as single caches, in some embodiments the caches 104 and 105 can represent multiple caches existing in a cache hierarchy operating as understood by one skilled in the art.

The memory controller 106 is configured to receive memory accesses from the processor cores 102 and 103 and provide those memory accesses to the memory modules 110, 111, and 112. In response to each memory access, the memory controller 106 receives data responsive to the memory access and provides that data to the cache of the processor core that generated the memory access. The memory controller 106 can also perform additional functions, such as buffering of memory access requests and responsive data, arbitration of memory accesses between the processor cores 102 and 103, memory coherency operations, and the like.

Each of the memory modules 110-112 includes a set of storage locations that can be targeted by memory access requests. In response to receiving a memory access from the memory controller 106, a memory module identifies the storage location targeted by the request and, depending on the type of memory access, provides the data to the memory controller 106 and/or modifies the data at the storage location. It will be appreciated that, while the memory modules 110-112 are illustrated in FIG. 1 as being part of the processor 100, in some embodiments one or more of the memory modules 110-112 can be separate from, or external to, the processor 100. For example, in some embodiments one or more of the memory modules 110-112 can be incorporated in a separate integrated circuit die from the processor 100, with the dies of the processor 100 packaged together in a common integrated circuit package.

In some embodiments, each of the memory modules 110-112 is of a different memory type having different memory characteristics, such as access speed, storage density, and the like. For example, in some embodiments the memory module 110 is a conventional dynamic random access memory (DRAM) memory module, the memory module 111 is a three-dimensional (3D) stacked DRAM memory module, and the memory module 112 is a phase change memory (PCM) memory module. Further, in some embodiments the different memory modules 110-112 may each be accessed more efficiently by a different type of processing unit. For example, the memory module 110 may have a greater access speed for memory accesses by a CPU than memory accesses by a GPU, while the memory module 111 has a greater access speed for memory accesses by the GPU than the CPU.

By employing memory modules of different types, the processor 100 allows applications executing at the processor cores 102 and 103 to place data in a memory module best suited for operations associated with that data. For example, in some embodiments the memory module 110 may have greater access speed and bandwidth than the memory module 111, while memory module 111 has greater memory density than memory module 110. If an application identifies that it needs to access a given block of data quickly, it can execute operations to move the block of data from the memory module 111 to the memory module 110. If the application subsequently identifies that it would be advantageous to have the block of data stored at the memory module 111, it can execute operations to transfer the block of data from the memory module 110 to the memory module 111. Thus, in the course of execution, an application can move data between the memory modules 110-112 in order to execute particular operations more efficiently.

To facilitate efficient access to data by executing applications, the processor 100 includes prefetchers 115, 116, and 117. The prefetcher 115 is configured to monitor memory accesses to the memory modules 110-112, to record a history of the memory accesses, to identify patterns in the memory access history, and to transfer data from the memory modules 110-112 to the caches 104 and 105 based on the identified patterns. The prefetcher 115 thereby increases the likelihood that memory access operations can be satisfied at the caches 104 and 105, improving processing efficiency. It will be appreciated that although the prefetcher 115 is depicted as being disposed between the memory controller 106 and the memory modules 110-112, in other embodiments it may be located between the processor cores 102 and 103 and the memory controller 106 in order to monitor memory access requests from the processor cores as they are communicated to the memory controller 106.

The prefetcher 116 is configured to monitor memory transfers and accesses between the memory modules 110 and 111, to record a history 118 of those memory transfers and accesses, to identify patterns in the memory transfer and access history 118, and to transfer data between the memory modules 110 and 111 based on the identified patterns. The patterns can be stride patterns, stream patterns, and the like. For example, the prefetcher 116 can identify that a transfer of data from a given address (designated Memory Address A) is frequently followed by a transfer of data from another memory address (designated Memory Address B). Accordingly, in response to a transfer of data at Memory Address A from the memory module 110 to the memory module 111, the prefetcher 116 can prefetch the data at Memory Address B from the memory module 110 to the memory module 111.

In some embodiments, the history 118 can be recorded at one of the memory modules of the processor 110, such as memory module 110. The large size of the memory module 110, relative to a set of registers at a conventional prefetcher, allows a relatively large amount of transfers and accesses to be recorded, and therefore more accurate and sophisticated patterns to be identified by the prefetcher 116. Further, in some embodiments, the history 118 is a history of direct transfers between the memory module 110 and the memory module 111; that is a history of transfers between the memory modules that do not transfer the data through a processor core.

The prefetcher 117 is configured to monitor memory transfers between the memory modules 111 and 112, to record a history 119 of those memory transfers, to identify patterns in the memory transfer history, and to transfer data between the memory modules 111 and 112 based on the identified patterns in a manner similar to that described above for the prefetcher 116. In some embodiments, the prefetchers 116 and 117 employ different pattern identification algorithms to identify the patterns in their respective data transfers. Further, the prefetchers 116 and 117 can employ different prefetch confidence thresholds to trigger prefetching.

In some embodiments, in addition to or instead of prefetching data between the memory modules 110-112, the prefetchers 116 and 117 can prefetch data from one of the memory modules 110-112 to the caches 104 and 105 based on data accesses to that memory module. For example, in some embodiments, the prefetcher 116 identifies patterns in memory accesses to the memory module 110 and, based on those memory accesses, prefetches data from the memory module 110 to the caches 104 and 105, in similar fashion to the prefetcher 115. However, because the prefetcher 116 monitors accesses only to the memory module 110, rather than all of the memory modules 110-112, it is better able to identify some access patterns than the prefetcher 115.

In some embodiments, in response to prefetching data between memory modules, the prefetchers 115-117 can notify an OS or other module of the transfer. This allows the OS to update page table entries for the transferred data, so that the page tables reflect the most up-to-date location of the transferred data. This ensures that the transfer of the data due to prefetching is transparent to a program executing at the processor 100.

In some embodiments, the prefetchers 115-117 can provide information, referred to as “hints”, to each other to assist in pattern identification and other functions. For example, in some embodiments the prefetcher 116 can increase its confidence level in a given prefetch pattern if it receives a prefetch hint from the prefetcher 117 that the prefetcher 117 has identified the same or similar prefetch pattern. The prefetchers 115-117 can also use the prefetch hints for other functions, such as power management. For example, in some embodiments each of the prefetchers 115-117 can be placed in a low-power mode to conserve power. In determining whether to enter the low-power mode, the prefetchers 115 can use the information included in the prefetch hints. For example, the prefetcher 116 can enter the low-power mode in response to identifying that the confidence levels associated with its identified access patterns are, on average, lower than the confidence levels associated with the access patterns identified at the prefetcher 117.

In some embodiments prefetch hints can also be provided by software executing at one or more of the processor cores 102 and 103. For example, in some scenarios the executing software may be able to anticipate likely patterns in upcoming transfers of data between memory modules, and can provide hints to the prefetchers 115-117 about these patterns. Based on these hints, the prefetchers 115-117 can generate their own patterns, or modify existing identified patterns or associated confidence levels. For example, in some embodiments software can provide a history to one or more of the prefetchers indicating patterns the software expects the prefetchers would develop as the software executes. The history can be in the form of an algorithm or an equation that represents a sequence of addresses to be accessed (e.g., a[i]=a_base+2i for a parallel prefetch pattern, a[i]=2+a[i−1] for a serial recursive prefetch pattern), or in the form of a statistical description (e.g., an address range, access density and locality, access distribution pattern, probability densities, also time dynamics of the same parameters for selected portions of the software).

In some embodiments, the hints provided by software can result from explicit instructions in the software inserted by a programmer. In some embodiments, a compiler can analyze code developed by a programmer and based on the analysis identify data access patterns and insert special prefetch instructions into the code to provide hints identifying the patterns to the prefetchers 115-117. The processor 100 can trigger preloading metadata indicated by the prefetch instructions from memory to a prefetcher either due to speculation or because of certain pre-conditions. In some embodiments, one or more of the prefetchers 115-117 can identify the statistical parameters from a program as it executes. Based on the parameters, the prefetchers 115-117 can build a profile of data accesses and relate the profile to a program counter value and portion of the program being executed. In response to determining that the portion of the program is to be executed again the processor 100 can trigger a prefetch based on the profile.

In some embodiments, an operating system can send prefetch requests to the prefetchers 115-117 based on its expected process scheduling. For example, on a context switch, the operating system could send migration requests to the prefetchers 115-117. Based on the requests, the prefetchers 115-117 would then migrate data to the memory module where it will be accessed more efficiently. This can reduce warmup time when the OS is scheduling a process to run on the processor 100. Similar migration requests can be sent to the prefetchers 115-117 in response to an interrupt to wake one or more portions of the processor 100 from a low-power state.

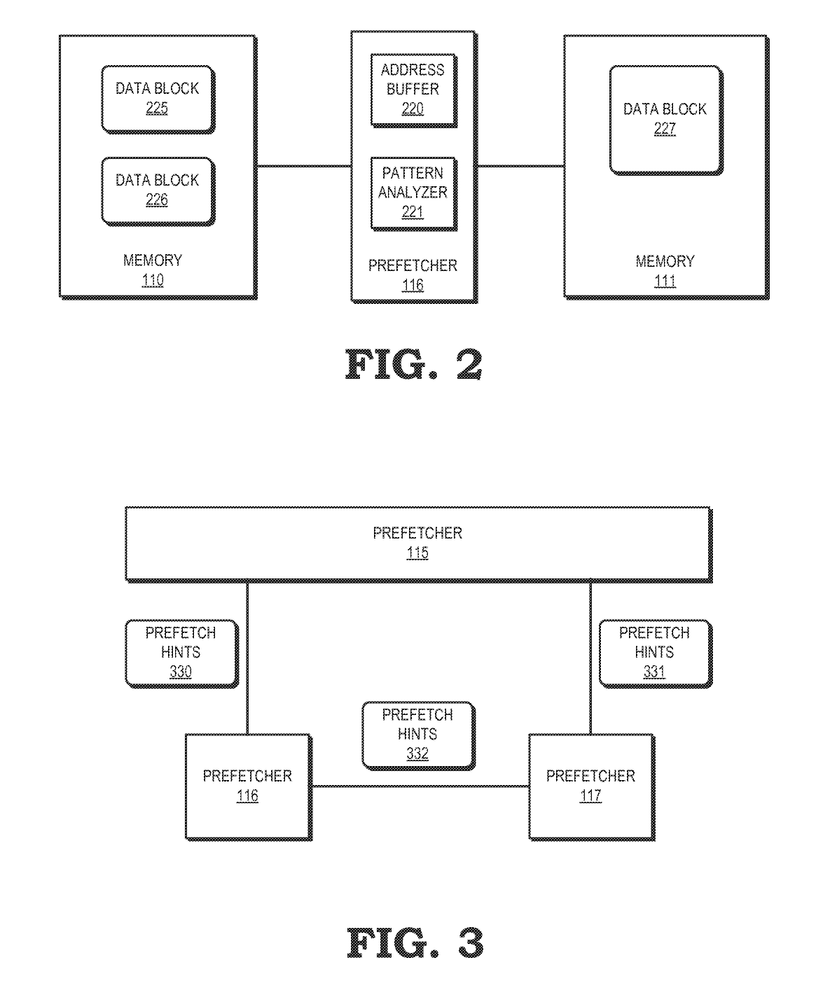

FIG. 2 illustrates an example of the prefetcher 116 prefetching data between the memory modules 110 and 111 in accordance with some embodiments. In the illustrated example, the prefetcher 116 includes an address buffer 220 and a pattern analyzer 221. The address buffer 220 stores a set of the memory addresses of the memory modules 110 and 111 that were most recently the targets of data transfers between the memory modules 110 and 111. The pattern analyzer 221 employs one or more pattern-identification algorithms, as understood by one skilled in the art, to identify patterns in the set of memory addresses at the address buffer 220. The pattern analyzer 221 can also identify a confidence level for each identified pattern. In response to the pattern analyzer 221 identifying a pattern with a confidence level exceeding a threshold, the prefetcher 116 transfers data between the memory modules 110 and 111 based on the pattern. In some embodiments the prefetcher 116 can include additional modules to assist in prefetching, such as sets of history registers or tables that provide a summary representation of one or more previously-identified memory access patterns.

To illustrate via an example, in some scenarios a program executing at the processor core 102 requests a transfer of data blocks 225 and 226 from memory module 111 to memory module 110. The memory addresses for the transfer of these data blocks are stored at the address buffer 220. Based on these memory addresses, the pattern analyzer 221 identifies that data block 227 at the memory module 111 is likely to be requested to transfer to the memory module 110. Accordingly, the prefetcher 116 transfers the data block 227 from the memory module 111 to the memory module 110. In some embodiments, the prefetcher 116 indicates to the program executing at the processor core 102 that the data has been prefetched, so that the program does not initiate a separate transfer of the data block 227.

FIG. 3 illustrates a block diagram of an example of the prefetchers 115-117 sharing prefetch hints in accordance with some embodiments. In the depicted example, the prefetcher 115 provides prefetch hints 330 and 331 to prefetcher 116 and 117 respectively. In addition, the prefetcher 116 provides prefetch hints 332 to prefetcher 117. In some embodiments, the prefetcher 117 provides prefetch hints (not shown for clarity) to prefetcher 116. The prefetch hints 330-332 indicate access patterns, and associated confidence levels, identified at the associated prefetcher. Based on the prefetch hints, the prefetchers 115-117 can adjust their own identified patterns and associated confidence levels. By sharing the prefetch hints 330-332, prefetching at each of the prefetchers 115-117 can be more accurate and efficient.

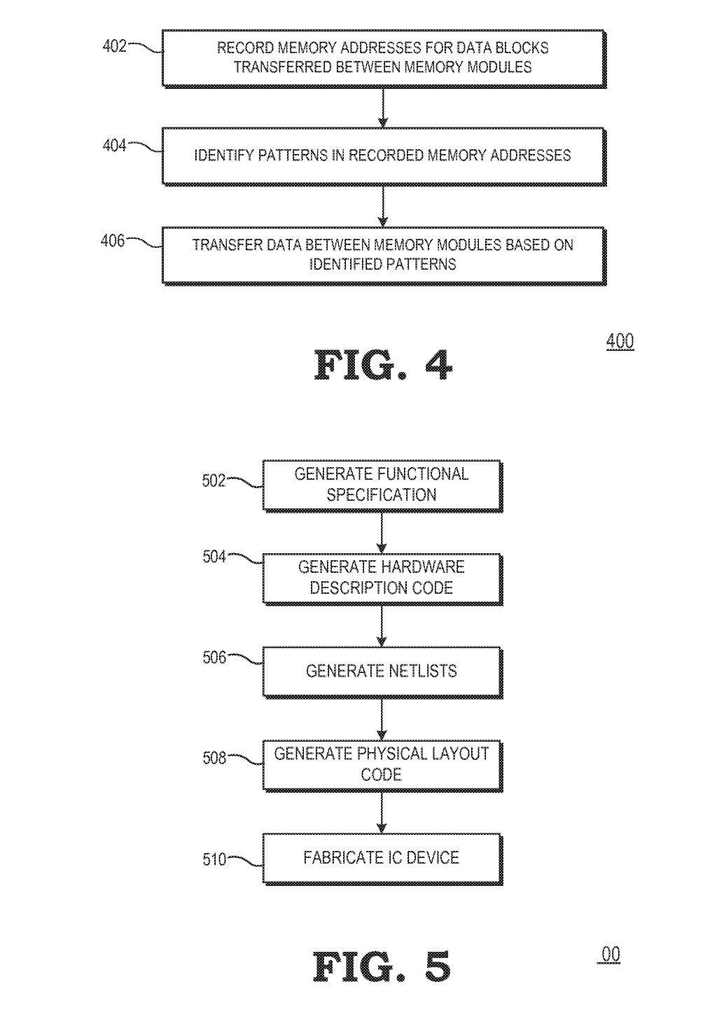

FIG. 4 is a flow diagram of a method 400 of prefetching data at memory modules of a processor in accordance with some embodiments. At block 402, the prefetcher 116 records the memory addresses of data that is transferred from the memory module 110 to the memory module 111. At block 404, the prefetcher 116 analyzes the recorded memory addresses to identify patterns in the addresses, such as stride patterns and the like. At block 406, the prefetcher 116 transfers data from the memory module 110 to the memory module 111 based on the identified patterns. The prefetcher 116 thus reduces the number of explicit data transfer requests that have to be generated at the processor cores 102 and 103, reducing processor overhead.

In some embodiments, the apparatus and techniques described above are implemented in a system comprising one or more integrated circuit (IC) devices (also referred to as integrated circuit packages or microchips), such as the processor described above with reference to FIGS. 1-4. Electronic design automation (EDA) and computer aided design (CAD) software tools may be used in the design and fabrication of these IC devices. These design tools typically are represented as one or more software programs. The one or more software programs comprise code executable by a computer system to manipulate the computer system to operate on code representative of circuitry of one or more IC devices so as to perform at least a portion of a process to design or adapt a manufacturing system to fabricate the circuitry. This code can include instructions, data, or a combination of instructions and data. The software instructions representing a design tool or fabrication tool typically are stored in a computer readable storage medium accessible to the computing system. Likewise, the code representative of one or more phases of the design or fabrication of an IC device may be stored in and accessed from the same computer readable storage medium or a different computer readable storage medium.

A computer readable storage medium may include any storage medium, or combination of storage media, accessible by a computer system during use to provide instructions and/or data to the computer system. Such storage media can include, but is not limited to, optical media (e.g., compact disc (CD), digital versatile disc (DVD), Blu-Ray disc), magnetic media (e.g., floppy disc, magnetic tape, or magnetic hard drive), volatile memory (e.g., random access memory (RAM) or cache), non-volatile memory (e.g., read-only memory (ROM) or Flash memory), or microelectromechanical systems (MEMS)-based storage media. The computer readable storage medium may be embedded in the computing system (e.g., system RAM or ROM), fixedly attached to the computing system (e.g., a magnetic hard drive), removably attached to the computing system (e.g., an optical disc or Universal Serial Bus (USB)-based Flash memory), or coupled to the computer system via a wired or wireless network (e.g., network accessible storage (NAS)).

FIG. 5 is a flow diagram illustrating an example method 500 for the design and fabrication of an IC device implementing one or more aspects in accordance with some embodiments. As noted above, the code generated for each of the following processes is stored or otherwise embodied in non-transitory computer readable storage media for access and use by the corresponding design tool or fabrication tool.

At block 502 a functional specification for the IC device is generated. The functional specification (often referred to as a micro architecture specification (MAS)) may be represented by any of a variety of programming languages or modeling languages, including C, C++, SystemC, Simulink, or MATLAB.

At block 504, the functional specification is used to generate hardware description code representative of the hardware of the IC device. In some embodiments, the hardware description code is represented using at least one Hardware Description Language (HDL), which comprises any of a variety of computer languages, specification languages, or modeling languages for the formal description and design of the circuits of the IC device. The generated HDL code typically represents the operation of the circuits of the IC device, the design and organization of the circuits, and tests to verify correct operation of the IC device through simulation. Examples of HDL include Analog HDL (AHDL), Verilog HDL, SystemVerilog HDL, and VHDL. For IC devices implementing synchronized digital circuits, the hardware descriptor code may include register transfer level (RTL) code to provide an abstract representation of the operations of the synchronous digital circuits. For other types of circuitry, the hardware descriptor code may include behavior-level code to provide an abstract representation of the circuitry's operation. The HDL model represented by the hardware description code typically is subjected to one or more rounds of simulation and debugging to pass design verification.

After verifying the design represented by the hardware description code, at block 506 a synthesis tool is used to synthesize the hardware description code to generate code representing or defining an initial physical implementation of the circuitry of the IC device. In some embodiments, the synthesis tool generates one or more netlists comprising circuit device instances (e.g., gates, transistors, resistors, capacitors, inductors, diodes, etc.) and the nets, or connections, between the circuit device instances. Alternatively, all or a portion of a netlist can be generated manually without the use of a synthesis tool. As with the hardware description code, the netlists may be subjected to one or more test and verification processes before a final set of one or more netlists is generated.

Alternatively, a schematic editor tool can be used to draft a schematic of circuitry of the IC device and a schematic capture tool then may be used to capture the resulting circuit diagram and to generate one or more netlists (stored on a computer readable media) representing the components and connectivity of the circuit diagram. The captured circuit diagram may then be subjected to one or more rounds of simulation for testing and verification.

At block 508, one or more EDA tools use the netlists produced at block 506 to generate code representing the physical layout of the circuitry of the IC device. This process can include, for example, a placement tool using the netlists to determine or fix the location of each element of the circuitry of the IC device. Further, a routing tool builds on the placement process to add and route the wires needed to connect the circuit elements in accordance with the netlist(s). The resulting code represents a three-dimensional model of the IC device. The code may be represented in a database file format, such as, for example, the Graphic Database System II (GDSII) format. Data in this format typically represents geometric shapes, text labels, and other information about the circuit layout in hierarchical form.

At block 510, the physical layout code (e.g., GDSII code) is provided to a manufacturing facility, which uses the physical layout code to configure or otherwise adapt fabrication tools of the manufacturing facility (e.g., through mask works) to fabricate the IC device. That is, the physical layout code may be programmed into one or more computer systems, which may then control, in whole or part, the operation of the tools of the manufacturing facility or the manufacturing operations performed therein.

In some embodiments, certain aspects of the techniques described above may implemented by one or more processors of a processing system executing software. The software comprises one or more sets of executable instructions stored or otherwise tangibly embodied on a non-transitory computer readable storage medium. The software can include the instructions and certain data that, when executed by the one or more processors, manipulate the one or more processors to perform one or more aspects of the techniques described above. The non-transitory computer readable storage medium can include, for example, a magnetic or optical disk storage device, solid state storage devices such as Flash memory, a cache, random access memory (RAM) or other non-volatile memory device or devices, and the like. The executable instructions stored on the non-transitory computer readable storage medium may be in source code, assembly language code, object code, or other instruction format that is interpreted or otherwise executable by one or more processors.

Note that not all of the activities or elements described above in the general description are required, that a portion of a specific activity or device may not be required, and that one or more further activities may be performed, or elements included, in addition to those described. Still further, the order in which activities are listed are not necessarily the order in which they are performed. Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims. Moreover, the particular embodiments disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below.

What is claimed is:

1. A method comprising:
prefetching data to a first memory module by a first prefetcher of a processor based on the first history of accesses to a first memory module; and
prefetching data to a second memory module by a second prefetcher of the processor based on a second history of accesses to the second memory module, the second history of accesses recorded independent of the first.

2. The method of claim 1, further comprising:
communicating one or more hints from the first prefetcher to the second prefetcher based on the first history of accesses; and
wherein prefetching data to the second memory comprises prefetching data to the second memory based on the second history of accesses and the one or more hints.

3. The method of claim 1, wherein the first history of accesses comprises a history of transfers to the first memory module from a third memory module.

4. The method of claim 3, wherein the history of transfers comprises a history of direct transfers not based on demand requests from a processor core of the processor.

5. The method of claim 3, wherein prefetching data to the first memory module comprises transferring data from the third memory module to the first memory module.

6. The method of claim 3, wherein the second history of accesses comprises a history of transfers from the third memory module to the second memory module.

7. The method of claim 1, further comprising:
recording a third history of accesses at a third prefetcher of the processor, the third history of accesses comprising a history of accesses to the first memory module and a history of accesses to the second memory module.

8. The method of claim 7, further comprising:
prefetching data from the first memory module to a cache of the processor based on the third history of accesses; and
prefetching data from the second memory module to the cache based on the third history of accesses.

9. The method of claim 1, wherein the first memory module is of a first memory type and the second memory module is of a second memory type different from the first memory type.

10. A method, comprising:
at a processor comprising a plurality of memory modules, recording a plurality of histories of data transfers between the memory modules; and
independently prefetching data to each of the plurality of memory modules based on the plurality of histories.

11. The method of claim 10, wherein prefetching data comprises:
transferring first data from a first memory module of the plurality of memory modules to a second memory module of the plurality of memory modules, the first memory module having a greater access speed for a processor core than the second memory module.

12. The method of claim 11, wherein prefetching data comprises:
transferring second data from the second memory module to the first memory module.

13. A system, comprising:
a first prefetcher to prefetch data to a first memory module based on a first history of accesses; and
a second prefetcher to prefetch data to a second memory module based on a second history of accesses.

14. The system of claim 13 wherein:
the first prefetcher is to communicate one or more hints to the second prefetcher based on the first history of accesses; and
the second prefetcher is to prefetch data to the second memory on the second history of accesses and the one or more hints.

15. The system of claim 13, further comprising:
a third memory module; and
wherein the first history of accesses comprises a history of transfers to the first memory module from a third memory module.

16. The system of claim 15, wherein the first prefetcher is to prefetch data to the first memory module by transferring data from the third memory module to the first memory module.

17. The system of claim 15, wherein the second history of accesses comprises a history of transfers to the second memory module from the third memory module.

18. The system of claim 15, further comprising:
a processor;
an operating system that communicates memory access requests to the processor.

19. The system of claim 15, wherein the first memory module is on a different semiconductor die than a processor that sends memory access requests to the first memory module, further comprising.

20. The system of claim 13, wherein the first memory module is of a first memory type and the second memory module is of a second memory type different from the first memory type.
